(19) United States
(12) Patent Application Publication
(10) Pub. No.: US 2004/0040214 A1
(43) Pub. Date: Mar. 4, 2004

(54) Door-mounted bug barrier apparatus

(76) Inventor: Garold B. Bitner II, Kokomo, IN (US)

Correspondence Address: S. Michael Bender, P.O. Box 530399, St. Petersburg, FL, 33747, US

(21) Appl. No.: 10/646,511

(22) Filed: Aug. 23, 2003

Related U.S. Application Data
(60) Provisional application No. 60/406,648, filed on Aug. 28, 2002.

(51) Int. Cl. E06B 7/16

(52) U.S. Cl. 49/475.1

(57) ABSTRACT

A bug barrier apparatus is provided for mounting on a door which moves along a door track and includes a support member which includes a top end and a bottom end. Door attachment means, attached to the support member, are provided for attaching the support member to the door. A set of flexible bristles is connected to the support member bottom end. Preferably, the door is a sliding glass door, and the flexible bristles extend from an edge of the sliding glass door and contact a door track. A pair of bug barrier apparatuses of the invention can be mounted on the trailing edge of the sliding glass door. The apparatus of the invention can be in a long-version form and a short-version form.

### CROSS-REFERENCE TO RELATED APPLICATION

This application claims priority based upon my copending Provisional Application Serial No. 60/406,648; filed Aug. 28, 2002.

### BACKGROUND OF THE INVENTION

1. Field of the Invention

The present invention relates generally to doors and, more particularly, to a device especially adapted for preventing unwanted matter from passing from outside a dwelling to inside the dwelling by moving around the door.

2. Description of the Prior Art

It is well known that unwanted matter, such as hot or cold air or bugs, can pass around a door from outside a dwelling to inside the dwelling. In this respect, throughout the years, a number of innovations have been developed relating to solving this problem, and the following U.S. patents are representative of some of those innovations: U.S. Pat. Nos. 4,589,464, 4,765,094, 4,807,392, and 5,465,532. More specifically, U.S. Pat. No. 4,589,464 discloses an insect barrier for sliding doors. The insect barrier therein relates to a barrier between two door panels, one which is fixed and one which slides. It is noted, however, that no provision is made for a barrier to prevent insects from passing around the sliding panel between the sliding panel and the track in which the sliding panel slides. To protect this especially vulnerable area from insect penetration, it would be desirable if an insect barrier were provided that prevents insects from passing around a sliding door panel via the track in which the sliding panel slides.

Each of U.S. Pat. Nos. 4,765,094 and 5,465,532 discloses a sealing device which is installed at the lower edge of a hinged door. Each respective device rides on the floor as the door is opened and closed. There is no disclosure of providing a sealing device for a sliding door. Moreover, each of the respective sealing devices are in the form of a single, solid device. Such a single solid device cannot provide close contact to substantially all portions of an irregular surface. It is noted that the tracks of sliding doors often have irregular surfaces, and the use of single, solid devices would not be satisfactory. In this respect, it would be desirable if a sealing device were provided that does not employ a single, solid device for contacting the surfaces of the tracks of sliding doors.

U.S. Pat. No. 4,807,392 may be of interest for its disclosure of an insect bait holder that is in the form of a door threshold. U.S. Pat. No. 5,205,063 may be of interest for its disclosure of an insect trap that is in the form of a tent-like structure.

Still other features would be desirable in a door-mounted bug barrier apparatus. Tracks of sliding doors often accumulate dirt, and such accumulated dirt may interfere with the proper operation of the sliding door. In this respect, it would be desirable if a device were provided that sweeps the tracks of the sliding door to move dirt away from the tracks.

A conventional sliding door having conventional tracks does not include a device serving as a track-located bug barrier and a track sweeper. In this respect, it would be desirable to provide a door-mounted bug barrier and track sweeper apparatus that is conveniently retrofitted to a conventional sliding door.

With respect to a sliding door that is retrofitted with a door-mounted bug barrier and track sweeper, in the process of retrofitting the sliding door, it would be desirable not to damage the sliding door. Moreover, if the door-mounted bug barrier and track sweeper had to be replaced, it would be desirable if easy replacement can be carried out.

Thus, while the foregoing body of prior art indicates it to be well known to use barriers at doors to keep unwanted matter from passing around the doors into a dwelling, the prior art described above does not teach or suggest a door-mounted bug barrier apparatus which has the following combination of desirable features: (1) prevents insects from passing around a sliding door panel via the track in which the sliding panel slides; (2) does not employ a single, solid sealing device for contacting the surfaces of the tracks of sliding doors; (3) sweeps the tracks of the sliding door to move dirt away from the tracks; (4) provides a door-mounted bug barrier and track sweeper that is conveniently retrofitted to a conventional sliding door; (5) does not damage the sliding door in the process of retrofitting the sliding door; and (6) provides for easy replacement of a door-mounted bug barrier and track sweeper when replacement is needed. The foregoing desired characteristics are provided by the unique door-mounted bug barrier apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a bug barrier apparatus for mounting on a door which moves along a door track and includes a support member which includes a top end and a bottom end. Door attachment means, attached to the support member, are provided for attaching the support member to the door. A set of flexible bristles is connected to the support member bottom end.

Preferably, the door is a sliding glass door, and the flexible bristles extend from an edge of the sliding glass door and contact a door track. A pair of bug barrier apparatuses of the invention can be mounted on the trailing edge of the sliding glass door. The set of flexible bristles has a bristle-set width which is sufficient to sweep the width of the door track.

The support member further includes a pair of side riser portions connected between the top end and the bottom end of the support member. A thru-channel is defined by the support member top end, the support member bottom end, and the pair of side riser portions. The thru-channel has an internal channel height and an internal channel width which permits the support member to be positioned around protuberances on a door edge. The support member top end, the pair of side riser portions, and the support member bottom end define a four-sided, frame-like support member.

Preferably, the door attachment means include adhesive strips. The adhesive strips can be comprised of foam, double-stick, adhesive tapes. With the long-version of the invention, the adhesive strips include a top adhesive strip attached to the support member top end and a bottom adhesive strip attached to the support member bottom end.

The support member is in a form of solid, planar support member, and the door attachment means are in a form of an adhesive strip attached to the solid, planar support member.

The embodiments of the invention prevent most insects and other bugs from entering a room or house by way of open spaces at the top and bottom of a sliding glass door. The set of flexible bristles prevent such entry. Only the smallest insects and bugs can squeeze past the set of flexible bristles. Moreover, the set of flexible bristles also serve to provide an insulative barrier against air flow. In this respect, the bug barrier apparatus of the invention also helps reduce heat loss during winter and the loss of cool, air conditioned air during summer. In addition, the set of flexible bristles serve to sweep the door tracks clean, providing a cleaner appearance.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining at least two preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved door-mounted bug barrier apparatus which has all of the advantages of the prior art and none of the disadvantages.

It is another object of the present invention to provide a new and improved door-mounted bug barrier apparatus which may be easily and efficiently manufactured and marketed.

It is a further object of the present invention to provide a new and improved door-mounted bug barrier apparatus which is of durable and reliable construction.

An even further object of the present invention is to provide a new and improved door-mounted bug barrier apparatus which is susceptible of a low cost of manufacture with regard to both materials and labor, and which accordingly is then susceptible of low prices of sale to the consuming public, thereby making such door-mounted bug barrier apparatus available to the buying public.

Still yet a further object of the present invention is to provide a new and improved door-mounted bug barrier apparatus which prevents insects from passing around a sliding door panel via the track in which the sliding panel slides.

Still another object of the present invention is to provide a new and improved door-mounted bug barrier apparatus that does not employ a single, solid sealing device for contacting the surfaces of the tracks of sliding doors.

Yet another object of the present invention is to provide a new and improved door-mounted bug barrier apparatus which sweeps the tracks of the sliding door to move dirt away from the tracks.

Even another object of the present invention is to provide a new and improved door-mounted bug barrier apparatus that provides a door-mounted bug barrier and track sweeper that is conveniently retrofitted to a conventional sliding door.

Still a further object of the present invention is to provide a new and improved door-mounted bug barrier apparatus which does not damage the sliding door in the process of retrofitting the sliding door.

Yet another object of the present invention is to provide a new and improved door-mounted bug barrier apparatus that provides for easy replacement of a door-mounted bug barrier and track sweeper when replacement is needed.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a front view showing a pair of long-version embodiments of the door-mounted bug barrier apparatus of the invention mounted on a trailing edge of a sliding glass door.

FIG. 2 is an enlarged front view of the lower embodiment of the door-mounted bug barrier apparatus shown in FIG. 1 that is contained in circled region 2 of FIG. 1.

FIG. 3 is a side view of the embodiment of the door-mounted bug barrier apparatus of FIG. 2 taken along line 3-3 thereof.

FIG. 4 is a rear view of the embodiment of the invention shown in FIG. 3 taken along line 4-4 thereof.

FIG. 5 is a front view of a short-version embodiment of the door-mounted bug barrier apparatus.

FIG. 6 is a side view of the embodiment of the short-version door-mounted bug barrier apparatus of FIG. 5 taken along line 6-6 thereof.

FIG. 7 is a rear view of the embodiment of the invention shown in FIG. 6 taken along line 7-7 thereof.

FIG. 8 is a front view showing a pair of short-version embodiments of the door-mounted bug barrier apparatus of the invention mounted on a trailing edge of a sliding glass door.

FIG. 9 is a fragamenatry, partial perspective view showing a pair of short-version embodiments of the door-mounted bug barrier apparatus of the invention mounted on a trailing edge of a sliding glass door.

FIG. 10 is a bottom view of the short-version embodiment of the invention shown in FIG. 5, showing dimensions of a preferred embodiment.

FIG. 11 is a plan view of the short-version embodiment of the invention shown in FIG. 5, showing dimensions of a preferred embodiment.

FIG. 12 is a side view of the short-version embodiment of the invention shown in FIG. 5, showing dimensions of a preferred embodiment.

### DESCRIPTION OF THE PREFERRED EMBODIMENT

With reference to the drawings, a new and improved door-mounted bug barrier apparatus embodying the principles and concepts of the present invention will be described.

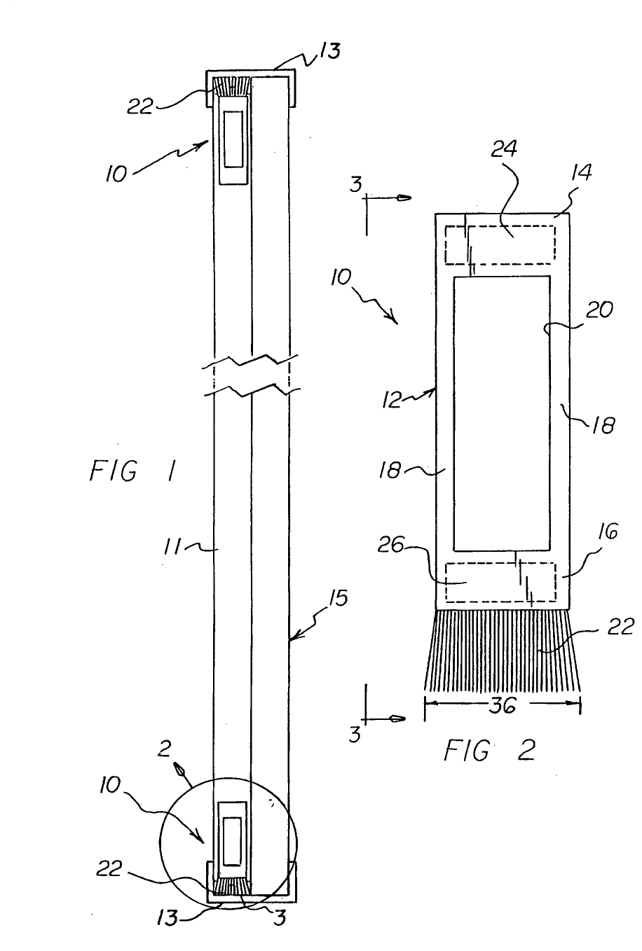

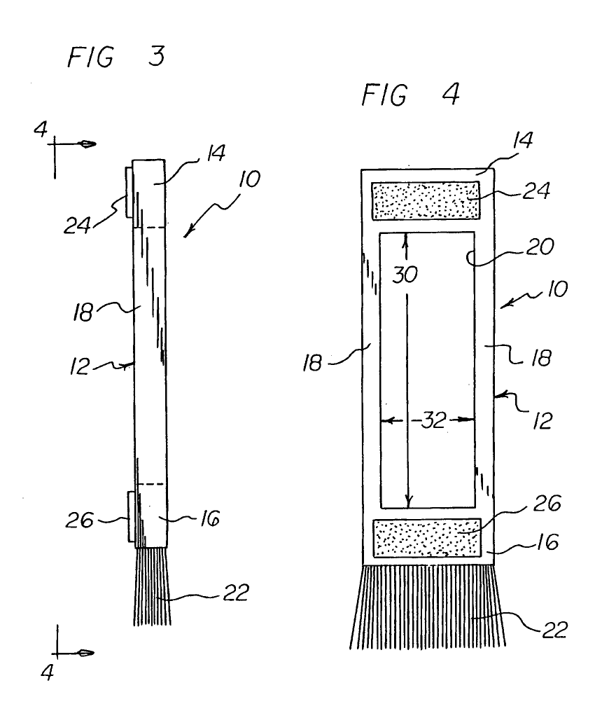

Turning to FIGS. 1-4, there is shown a first embodiment of the door-mounted bug barrier apparatus of the invention generally designated by reference numeral 10. In the first embodiment, a bug barrier apparatus 10 is provided for mounting on a door 11 which moves along a door track 13 and includes a support member 12 which includes a top end 14 and a bottom end 16. Door attachment means, attached to the support member 12, are provided for attaching the support member 12 to the door 11. A set of flexible bristles 22 is connected to the support member bottom end 16.

Preferably, the door 11 is a sliding glass door 11, and the flexible bristles 22 extend from an edge of the sliding glass door 11 and contact a door track 13. A pair of bug barrier apparatuses of the invention can be mounted on the trailing edge of the sliding glass door 11. The set of flexible bristles 22 has a bristle-set width 36 which is sufficient to sweep the width of the door track 13.

With the embodiment of the invention shown in FIGS. 1-4, the support member 12 further includes a pair of side riser portions 18 connected between the top end 14 and the bottom end 16 of the support member 12. A thru-channel 20 is defined by the support member top end 14, the support member bottom end 16, and the pair of side riser portions 18. The thru-channel 20 has an internal channel height 30 and an internal channel width 32 which permits the support member 12 to be positioned around protuberances on a door edge. The support member top end 14, the pair of side riser portions 18, and the support member bottom end 16 define a four-sided, frame-like support member 12.

Preferably, the door attachment means include adhesive strips. The adhesive strips can be comprised of foam, double-stick, adhesive tapes. With the long-version of the invention, the adhesive strips include a top adhesive strip 24 attached to the support member top end 14 and a bottom adhesive strip 26 attached to the support member bottom end 16.

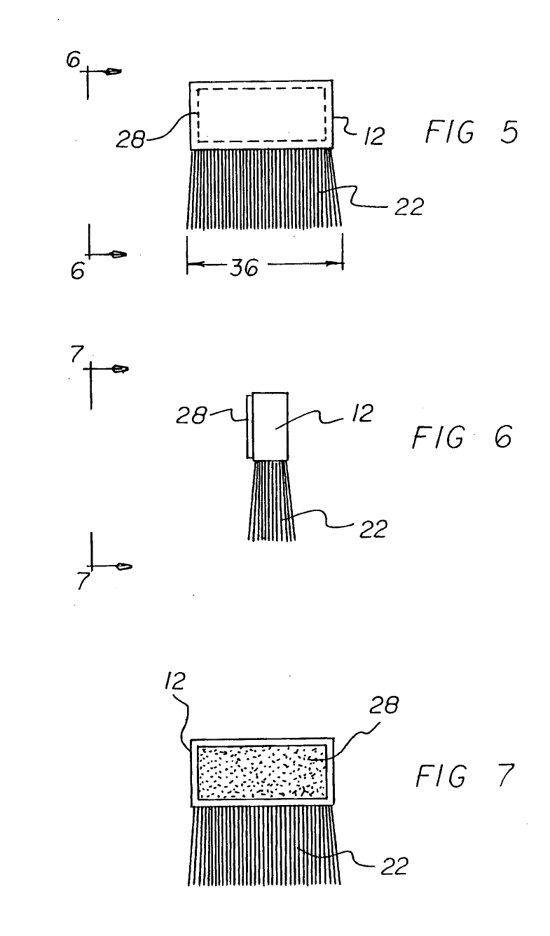

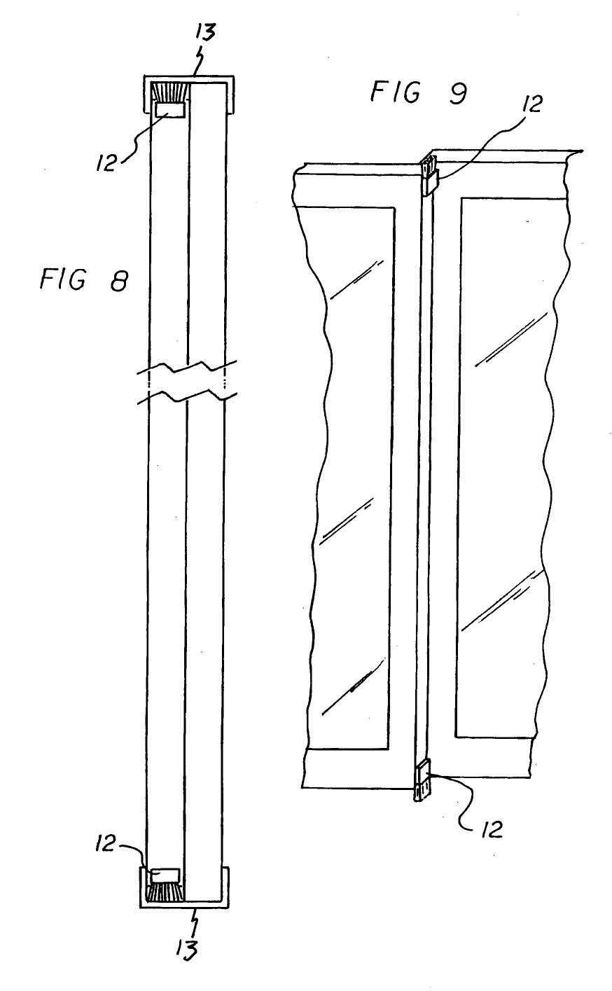

With the embodiment of the invention shown in FIGS. 5-12, the support member 12 is in a form of solid, planar support member 12, and the door attachment means are in a form of an adhesive strip 28 attached to the solid, planar support member 12.

The long-version of the invention is especially useful with sliding glass doors 11 that have protuberances on a door edge. For example, door edges of some sliding glass doors 11 include assembly screw heads that protrude ⅛ inch from the door edges. In this respect, the four-sided, frame-like support member 12 of the long-version of the invention provides a thru-channel 20 into which the assembly screw heads extend.

To use a pair of the first embodiment of the invention, which are the long-versions shown in FIGS. 1-4, the top adhesive strip 24 and the bottom adhesive strip 26 are applied to selected portions of edge of the sliding glass door 11. It is noted that the sliding glass door 11 is adjacent to the fixed glass door portion 15. More specifically, one bug barrier apparatus 10 of the invention is fixed to the door edge near the top of the sliding glass door 11 so that the set of flexible bristles 22 contact the top door track 13. A second bug barrier apparatus 10 of the invention is fixed to the door edge near the bottom of the sliding glass door 11 so that the set of flexible bristles 22 contact the bottom door track 13.

To use a pair of the second embodiment of the invention, which are short-versions shown in FIGS. 5-12, the adhesive strip 28 of one short-version bug barrier apparatus of the invention is fixed to the door edge near the top of the sliding glass door 11 so that the set of flexible bristles 22 contact the top door track 13. The adhesive strip 28 of a second short-version bug barrier apparatus of the invention is fixed to the door edge near the bottom of the sliding glass door 11 so that the set of flexible bristles 22 contact the bottom door track 13.

The embodiments of the invention prevent most insects and other bugs from entering a room or house by way of open spaces at the top and bottom of a sliding glass door 11. The set of flexible bristles 22 prevent such entry. Only the smallest insects and bugs can squeeze past the set of flexible bristles 22. Moreover, the set of flexible bristles 22 also serve to provide an insulative barrier against air flow. In this respect, the bug barrier apparatus 10 of the invention also helps reduce heat loss during winter and the loss of cool, air conditioned air during summer. In addition, the set of flexible bristles 22 serve to sweep the door tracks 13 clean, providing a cleaner appearance.

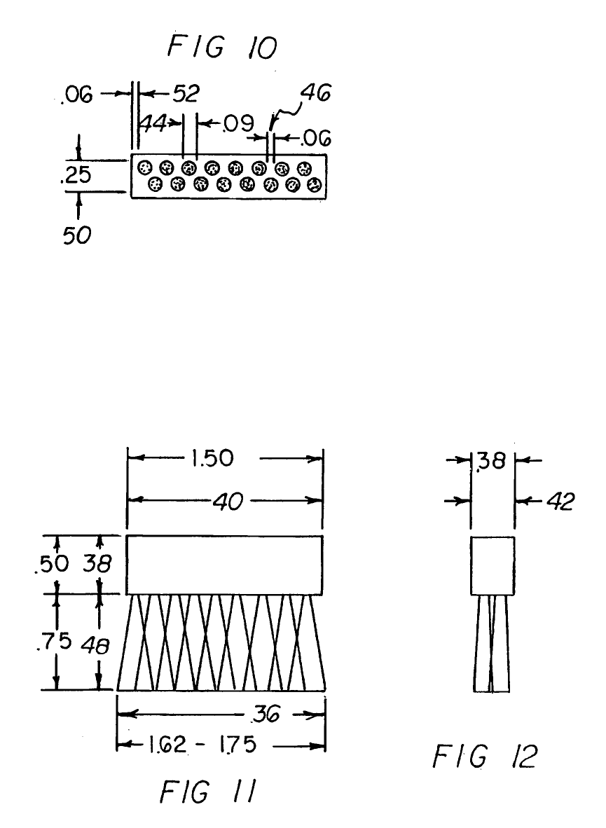

As shown in FIGS. 10-12, a commercially ready, preferred embodiment of the invention (short version) can have the dimensions as described below. The bristle-set width 36 can be in a range of 1.62 to 1.75 inches. The bristle head height 38 can be 0.50 inch. The bristle head length 40 can be 1.50 inch. The bristle head width 42 can be 0.38 inch. The bristle group diameter 44 can be 0.09 inch. The bristle group to group spacing 46 can be 0.06 inch. The bristle length 48 can be 0.75 inch. The bristle-set transverse width 50 can be 0.25 inch. The spacing 52 between an end bristle group and an edge of the bristle head can be 0.06 inch.

The components of the door-mounted bug barrier apparatus of the invention can be made from inexpensive and durable metal and/or plastic materials. For example, the support members and the set of flexible bristles can be made from plastic.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved door-mounted bug barrier apparatus that is low in cost, relatively simple in design and operation, and which may advantageously be used to prevent insects from passing around a sliding door panel via the track in which the sliding door panel slides. With the invention, a door-mounted bug barrier apparatus is provided which does not employ a single, solid sealing device for contacting the surfaces of the tracks of sliding doors. With the invention, a door-mounted bug barrier apparatus is provided which sweeps the tracks of the sliding door to move dirt away from the tracks. With the invention, a door-mounted bug barrier apparatus provides a door-mounted bug barrier and track sweeper that is conveniently retrofitted to a conventional sliding door. With the invention, a door-mounted bug barrier apparatus is provided which does not damage the sliding door in the process of retrofitting the sliding door. With the invention, a door-mounted bug barrier apparatus provides for easy replacement of a door-mounted bug barrier and track sweeper when replacement is needed.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A bug barrier apparatus for mounting on a door which moves along a door track, comprising:
a support member which includes a top end and a bottom end,
door attachment means, attached to said support member, for attaching said support member to the door, and
a set of flexible bristles connected to said support member bottom end.

2. The apparatus of claim 1 wherein:
the door is a sliding glass door, and
said flexible bristles extend from the sliding glass door and contact a door track.

3. The apparatus of claim 2 wherein said set of flexible bristles has a bristle-set width which is sufficient to sweep the width of the door track.

4. The apparatus of claim 1 wherein said support member further includes:
a pair of side riser portions connected between said top end and said bottom end of said support member, and
a thru-channel defined by said support member top end, said support member bottom end, and said pair of side riser portions.

5. The apparatus of claim 4 wherein said thru-channel has an internal channel height and an internal channel width which permits said support member to be positioned around protuberances on a door edge.

6. The apparatus of claim 5 wherein said support member top end, said pair of side riser portions, and said support member bottom end define a four-sided, frame-like support member.

7. The apparatus of claim 1 wherein said door attachment means include adhesive strips.

8. The apparatus of claim 7 wherein said adhesive strips are comprised of foam, double-stick, adhesive tapes.

9. The apparatus of claim 7 wherein said adhesive strips include:
a top adhesive strip attached to said support member top end, and
a bottom adhesive strip attached to said support member bottom end.

10. The apparatus of claim 1 wherein:
said support member is in a form of solid, planar support member, and
said door attachment means are in a form of an adhesive strip attached to said solid, planar support member.
